(19) United States
(12) Patent Application Publication
(10) Pub. No.: US 2022/0069292 A1
(43) Pub. Date: Mar. 3, 2022

(54) ABUSE-TOLERANT LITHIUM ION BATTERY CATHODE BLENDS WITH SYMBIOTIC POWER PERFORMANCE BENEFITS

(71) Applicant: A123 Systems, LLC, Waltham, MA (US)

(72) Inventors: Wesley Hoffert, Maynard, MA (US); Derek Johnson, Fort Collins, CO (US); Brian Chiou, Billerica, MA (US); Maha Rachid Hammoud, Westland, MI (US); Chuanjing Xu, Ann Arbor, MI (US); Theodore Grimm, Bolton, MA (US)

(21) Appl. No.: 17/418,538

(22) PCT Filed: Jan. 3, 2020
(86) PCT No.: PCT/US2020/012272

§ 371 Date: Jun. 25, 2021

Related U.S. Application Data
(60) Provisional application No. 62/789,399, filed on Jan. 7, 2019.

(51) Int. Cl. H01M 4/36; H01M 10/0525; H01M 4/525; H01M 4/505; H01M 4/58; C01G 53/00; C01B 25/45

(52) U.S. Cl. CPC H01M 4/364; H01M 10/0525; H01M 4/525; H01M 4/505; H01M 4/5825; C01P 2006/40; C01B 25/45; C01P 2004/61; C01P 2004/62; C01P 2004/64; C01P 2006/12; C01G 53/50

(57) ABSTRACT

Methods and systems are provided for a blend of cathode active materials. In one example, the blend of cathode active materials provides a high power battery with low direct current resistance while improving lithium ion cell safety performance. Methods and systems are further provided for fabricating the cathode active material blend and a battery including the blend.

### CROSS-REFERENCE TO RELATED APPLICATION

The present application claims priority to U.S. Provisional Application No. 62/789,399, entitled “ABUSE-TOLERANT LITHIUM ION BATTERY CATHODE BLENDS WITH SYMBIOTIC POWER PERFORMANCE BENEFITS”, and filed on Jan. 7, 2019. The entire contents of the above-listed application are hereby incorporated by reference for all purposes.

### FIELD

The present description relates generally to materials and methods used in secondary lithium-ion batteries.

### BACKGROUND AND SUMMARY

Consumer appetite for electric vehicles has been increasing in recent years. This interest in electric vehicles has been motivated by rising prices of petroleum fuel, the convenience of avoiding frequent trips to gas refueling stations, and the desire to reduce vehicular carbon dioxide emissions. To meet the growing demand, car manufacturers are taking a variety of novel technological approaches toward vehicle propulsion systems. There are currently several subclasses of electric vehicles (EVs) which differ on their level of hybridization between traditional internal combustion engines (ICEs) and electric motors. These subclasses therefore include battery electric vehicles (BEVs), plug-in hybrid electric vehicles (PHEVs), and mild-hybrid electric vehicles (MHEVs).

One defining characteristic of MHEVs is the inclusion of a 48-volt battery pack comprised of 12-14 lithium-ion power cells connected in series. These modules must be capable of accepting and delivering pulses of electric charge at very high rates, sometimes approaching 40 C. This capability requires Li-ion active materials, conductive additives, and cell designs that are biased for high rate capability. This capability is further coupled to a requirement for low direct current resistance (DCR) to prevent excessive self-heating that would necessitate expensive auxiliary thermal management systems.

With pulse times for high-rate charge acceptance and delivery lasting as long as 60 seconds, MHEV battery state-of-charge (SOC) can undergo swings from one extreme to another in a short period of time. Therefore, monitoring and controlling the SOC through use of an on-board battery management system (BMS) is vital to preserving the rated battery performance. Typically, a BMS calculates the SOC for individual cells based on cell voltage. This calculation is most accurate when the relationship between voltage and SOC is sloping and linear, which is one characteristic that defines a Li-ion cell containing positive electrodes that employ LiNiₓCo_{y}Mn_{z}O₂ (NCM or NMC) active materials. For MHEV applications, the usable SOC range of a 48-volt battery pack is typically 20-80%.

NCM active materials have undergone massive adoption in Li-ion cell designs, largely owing to a favorable combination of good theoretical energy densities, compatibility with existing Li-ion electrolytes, sloped and smooth voltage profiles, and relatively low cost of manufacturing at scale. However, compared to oxide-free olivine-structured active materials, such as lithium iron phosphate (LFP), NCM active materials suffer from an inherent tendency to release oxygen under abuse conditions such as nail penetration, hot box testing, and overcharge. When combined with flammable organic liquids that make up an electrolyte, cells that employ these active materials are prone to catastrophic failure modes. Mitigating this hazard is an active area of research and development, and these efforts have resulted in many technologies that have been implemented at the material and cell levels. One approach in the prior art described, for example, in US 9,178,215, US 9,793,538, US 2014/0322605, US 2017/0352876, and US 2014/0138591, has been to physically blend the NCM active material particles with other materials, such as olivine-structured LFP or lithium iron manganese phosphate (LFMP or LMFP), for which oxygen release is disfavored under abuse conditions.

However, the inventors herein have recognized potential issues with physically blending NCM active material particles with other materials, such as LFP and LFMP. In one example, design considerations for Li-ion cells that require a low DCR over a wide SOC range imply that the voltage drop under heavy current load is minimized. Translated to the material level, this requirement means that the metal-centered oxidation-reduction, or redox, reaction(s) that accompany Li-ion insertion at the positive electrode must occur with a small overpotential. In the case of blended cathodes wherein the blend components are LFMP and NCM, the overpotential during a current pulse can cause a voltage swing that may require traversing a voltage gap between the thermodynamic half-cell reduction potentials of:
the transition-metal centered redox reaction in NCM and the Fe-centered redox reaction in LFMP;
the transition-metal centered redox reaction in NCM and the Mn-centered redox reaction in LFMP; and
the transition between the Fe-centered and Mn-centered redox reactions in LFMP.

In any of the above scenarios, a SOC swing that necessitates a voltage swing containing any of the transient voltage ranges described will often be accompanied by a significant increase in DCR.

The voltage at which each of the cathode half reactions occurs is intrinsic and cannot be modified. However, contrary to conventional wisdom, the inventors herein have discovered that by careful manipulation of the ratio of the active materials combined with an ability to tune the composition of the active materials, the SOC at which these DCR increases occur may be controlled. In this manner, synergetic blended cathode systems may be developed in which the DCR stays relatively constant within the target SOC range for MHEV applications.

There is recent academic literature describing a similar effect between LFMP and spinel-structured LiMn_{1.9}Al_{0.1}O₄. Klein et al. attributed the buffering, synergetic rate capability effect between the two materials at roughly 4.0 V vs. Li to reduced electrode polarization. The proposed mechanism for this effect involves electron transfer between the two active materials (Klein, A.; Axmann, P.; Wohlfahrt-Mehrens, M. “Synergetic Effects of LiFe_{0.3}Mn_{0.7}PO₄—LiMn_{0.9}Al_{0.1}O₄ Blend Electrodes,” J. Power Sources 2016, vol. 309, pp. 169-177, and Klein, A.; Axmann, P.; Wohlfahrt-Mehrens, M. “Origin of the Synergetic Effects of LiFe_{0.3}Mn_{0.7}PO₄— Spinel Blends via Dynamic In Situ X-ray Diffraction Measurements,” J. Electrochem. Soc. 2016, vol. 163, pp. A1936-A1940).

Enhanced cycle life and capacity at 2 C discharge rates using a blend of 10% LiMn_{0.6}Fe_{0.4}PO₄ and 90% LiNi_{0.33}Co_{0.33}Mn_{0.33}O₂ (NCM111) was reported in the scientific literature by Tian et al. (Wang, Q.; Tian, N.; Xu, K.; Han, L.; Zhang, J.; Zhang, W.; Guo, S.; You, C. “A Facile Method of Improving the High Rate Cycling Performance of LiNi_{1/3}Co_{1/3}Mn_{1/3}O₂ Cathode Material,” J. Alloys Compd. 2016, vol. 686, pp. 267-272). A buffering effect was also quantified with lithium cobalt oxide (LCO) and LFP electrodes short-circuited together by Huebner et al. (Heubner, C.; Liebmann, T.; Lammel, C.; Schneider, M.; Michaelis, A. “Insights into the Buffer Effect Observed in Blended Lithium Insertion Electrodes”, J. Power Sources 2017, vol. 363, pp. 311-316).

The inventors have identified the above problems and have determined solutions to at least partially solve them. As detailed herein, a cathodic configuration and a lithium-ion battery comprising said cathodic configuration is presented to overcome the difficulties presented above. In one example, a blended cathode active material comprises a blend of a LFMP and a NCM, wherein there is less of the LFMP than the NCM by weight. In an additional or alternative example, a lithium-ion battery comprises a cathode and an anode in communication via an electrolyte, wherein the cathode comprises a LFMP and a NCM, wherein there is more of the NCM than the LFMP and the LFMP comprises 65% Mn. The blend of the LFMP and the NCM confers complementary benefits of high power and low DCR to the lithium-ion battery. The inventors have also unexpectedly discovered that lithium-ion cells comprising blended active material cathodes as described herein provide improved abuse tolerance characteristics. For example, the blended active material cathodes show improved performance when subjected to nail penetration abuse tests, even in large format (8 Ah) cells that employ graphitic anodes and carbonate-based electrolytes.

As a further example, a method comprises mixing a LFMP with a solvent to obtain a mixture, adding conductive carbon to the mixture, adding a binder to the mixture, adding a NCM to the mixture, casting the mixture onto a current collector, evaporating the solvent from the mixture to obtain a dry active material blend, and calendaring the dry active material blend. As such, a cathode comprising the dry active material blend may be incorporated into a lithium-ion battery, wherein said lithium-ion battery is thereby conferred the benefits described hereinabove.

It will be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an example method for manufacturing a lithium-ion battery comprising a blended active material cathode, in accordance with at least one embodiment of the present disclosure.

FIG. 2 shows plots depicting charge and discharge DCR vs. SOC measured by hybrid pulse power characterization at 23° C.

FIG. 3 shows a plot depicting discharge direct current resistance (DCR) vs. state-of-charge (SOC) for batteries with blended cathode materials.

FIG. 4 shows a flow chart for preparing an electrode with blended cathode materials.

### DETAILED DESCRIPTION

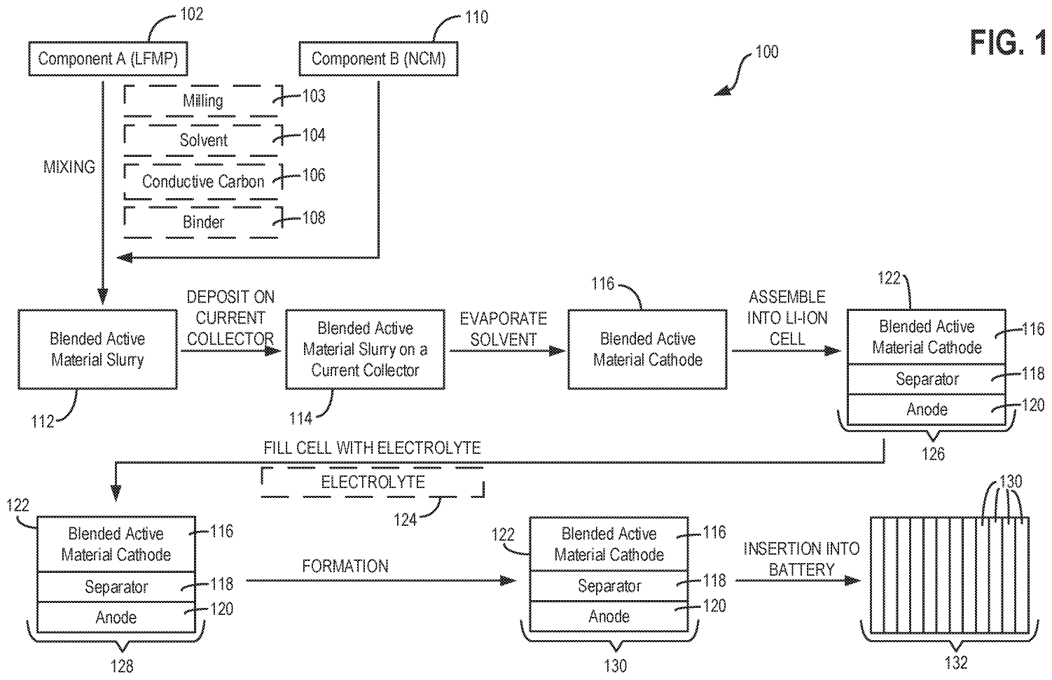

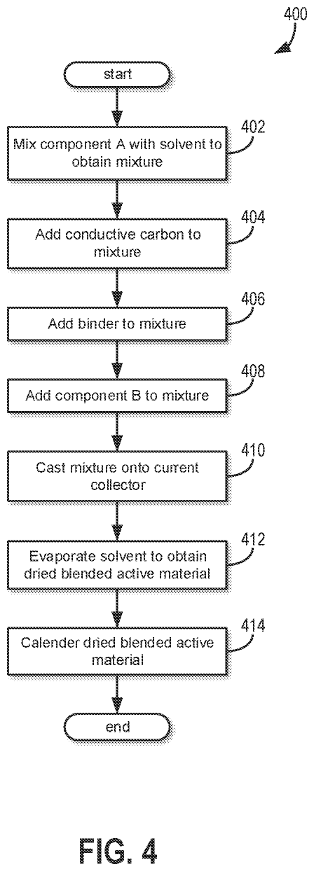

The present disclosure relates to materials and methods for blending cathode active materials, such as a blend of lithium iron manganese phosphate (LFMP) and lithium nickel cobalt manganese oxide (NCM), or blends of other lithium phosphates and/or high-nickel oxides. The blended cathode active materials may be used in cathodes of lithium-ion batteries, including high power batteries, and including cathodes of such batteries as found in mild-hybrid electric vehicles (MHEVs). The cathode active materials may be in the form of a powder and may comprise secondary particles, or said materials may be in the form of an electrode, as shown in the schematic of one embodiment of a manufacture of a lithium-ion battery in FIG. 1. The blended cathode active materials may be formed by wet-mixing components together along with a solvent, conductive carbon, and binder, as described in the example method of FIG. 4.

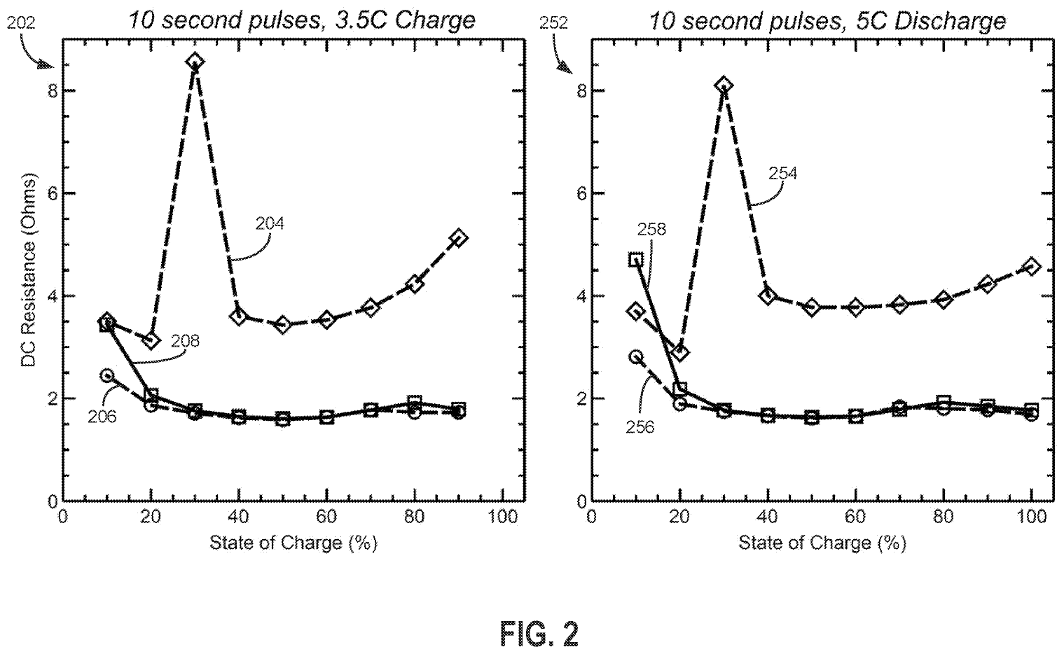

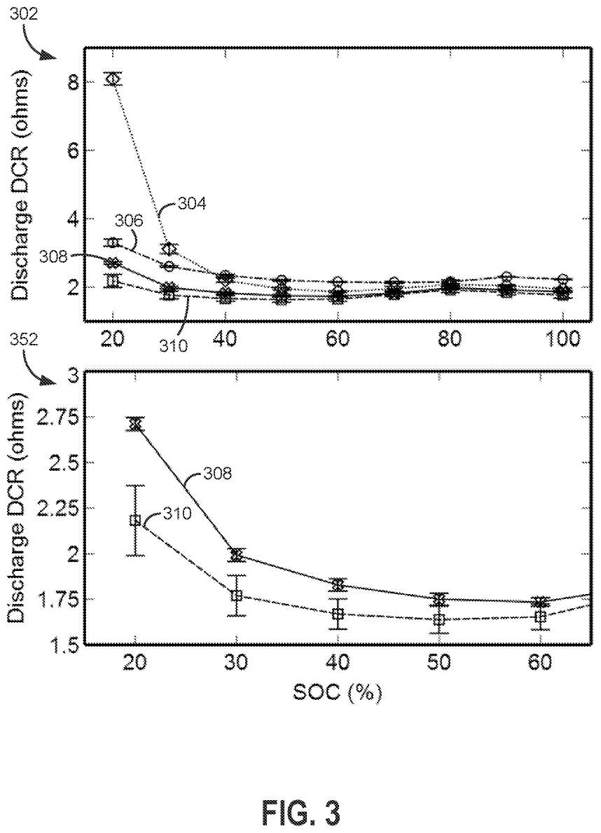

The inventors herein have unexpectedly found that some LFMP-NCM blended active materials provide increased abuse tolerance relative to conventional unblended high-nickel oxide active materials, while still retaining characteristic gently sloping voltage plateaus of unblended high-nickel oxide active materials. These blended active materials have also been proven to provide low direct current resistance (DCR) between 20% and 80% state-of-charge (SOC) relative to conventional unblended LFMP materials. For example, FIG. 2 shows results for test runs of battery cells comprising unblended LFMP and NCM and blended LFMP and NCM. FIG. 3 further shows test results for discharge of battery cells comprising various blended cathode active materials. As shown in FIGS. 2-3, battery cells comprising the blended cathode active materials show a synergetic power performance in which said blended materials perform similar to unblended NCM in terms of DCR. Further, a low weight ratio of high-manganese LMFP is observed to function as an effective additive for preserving performance in blended cathode active materials relative to other blended cathode active materials and unblended counterparts.

For purposes of clarity and continuity, it should be appreciated that in the following description, multiple names may be used to refer to the same concept, idea, or item, and vice versa. For example, it should be understood that “high nickel active cathode materials” may be used herein to refer to all electrochemically active cathode powders used in lithium-ion batteries including, but not limited to, LiNi_{0.33}Co_{0.33}Mn_{0.33}O₂ (NCM111), LiMn_{x′}Ni_{2-x′}O₄, LiNiPO₄, LiCoPO₄, or lithium nickel manganese oxide (layered or spinel structure), or any precursors of said materials, such as Ni_{x′}Mn_{y′}Co_{1-x′-y′}(OH)₂ and NiCo_{y′}Al_{1-x′-y′}(OH)₂. Further, “high nickel cathodes” may be used to refer to all cathodes that are constructed from, include, and/or use the aforementioned high nickel active cathode materials for lithium-ion transport between the cathode and the electrolyte of a battery cell. Thus, a cathode referred to as a “NCM cathode” is a cathode that comprises NCM as an electrochemically active cathode material, for example.

Additionally, in the following description, numerous specific details are set forth in order to provide a thorough understanding of the presented concepts. The presented concepts may be practiced without some or all of these specific details. In other instances, well-known process operations have not been described in detail so as to not unnecessarily obscure the described concepts. While some concepts will be described in conjunction with the specific embodiments, it will be understood that these embodiments are not intended to be limiting.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” or “a mixture of” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “excess lithium,” or “lithium-rich,” or “excess phosphate,” or “phosphate-rich” refers to the amount of lithium or phosphate in the overall composition in excess of that needed to form a stoichiometric olivine or layered compound.

As used herein, the term “specific capacity” refers to the capacity per unit mass of an electroactive material in a positive electrode and has units of milliampere-hour/gram (mAh/g).

As used herein, the term “dopant” may include elements, ions, polyatomic ions, and/or chemical moiety apart from a defining composition of a given material. Further, a dopant may improve electrochemical, physicochemical, and/or safety properties of a given material. In one example, a dopant added to LFMP may include any element, ion, polyatomic ion, or chemical moiety besides Li, Fe, Mn, or PO₄. In another example, a dopant added to NCM may include any element, ion, polyatomic ion, or chemical moiety besides Li, Ni, Co, Mn, or O₂.

Turning to FIG. 1, schematic 100 depicts an example process for fabricating LFMP-NCM blended active cathode materials, in the form of a slurry or in the form of a cathode, and for fabricating a lithium-ion battery utilizing the blended active cathode materials.

Component A 102 of the blended active cathode materials may be LFMP 102. LFMP 102 is a cathode active material with an overall composition of LiₐFe_{1-x-y}MnₓD_{y}(PO₄)_{z}F_{w} wherein 1.0≤a≤1.10, 0.45<x≤0.85, 0≤y≤0.1, 1.0<z≤1.1, 0≤w<0.1, and D may be one or more dopant metals selected from the group consisting of Ni, V, Co, Nb, and combinations thereof. Component A 102 may be in the form of a powder comprising particles. Component A 102 may have an olivine structure.

In some embodiments, 1.0≤a≤1.05, 1.0<a≤1.05, 1<a<1.05, 1.0<a≤1.10, or 1<a<1.10. In some embodiments, 0.50≤x≤0.85, 0.50≤x≤0.80, 0.55≤x≤0.80, 0.55≤x≤0.75, 0.60≤x≤0.75, 0.60≤x ≤0.70, 0.60<x<0.70, 0.65≤x<70, or x=0.65. In one example, 0.60≤x≤0.85. In a further example, 0.65≤x≤0.85. In some embodiments, 1.0<z≤1.05 or 1.0<z≤1.025.

In some embodiments, the overall composition of LMFP 102 may comprise at least 40 wt %, 45 wt %, 50 wt %, 55 wt %, 60 wt %, 65 wt %, 70 wt %, 75 wt %, or 80 wt % of Mn. In one example, the overall composition of LMFP 102 may comprise at least 60 wt % of Mn. In a further example, the overall composition of LMFP 102 may comprise at least 65 wt % of Mn.

In some embodiments, the overall composition of LMFP 102 may comprise up to about 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of the dopants. In certain embodiments, the overall composition of LMFP 102 may comprise up to 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of Ni. In certain embodiments, the overall composition of LMFP 102 may comprise up to 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of V. In certain embodiments, the overall composition of LMFP 102 may comprise up to 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of Co. In certain embodiments, the overall composition of LMFP 102 may comprise up to 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of Nb. In certain embodiments, the overall composition of LMFP 102 may comprise up to 0.1 mol %, 0.5 mol %, 1 mol %, 1.5 mol %, 2 mol %, 2.5 mol %, 3 mol %, 3.5 mol %, 4 mol %, 4.5 mol %, 5 mol %, 6 mol %, 7 mol %, 8 mol %, 9 mol %, or 10 mol % of F.

Doping with hypervalent transition metals such as Nb or V may contribute to advantages of olivine materials for rechargeable lithium-ion battery applications. An advantageous role of the one or more dopants may be several-fold and include increased electronic conductivity of the olivine material and may limit sintering of olivine material particles to allow substantially full utilization of lithium capacity during fast charge/discharge of a given lithium-ion battery.

The excess lithium and excess phosphate in the overall composition need not provide a non-stoichiometric olivine compound in a single olivine structure or single olivine phase. Rather, the excess lithium and/or phosphate may be present, for example, as secondary phases and the like in conjunction with an olivinic phase. Typically, the dopants, such as Ni, V, Co, Nb, and/or F, are doped into and reside on lattice sites of the olivine structure to form an olivinic phase. However, small amounts of dopant-rich secondary phases may be tolerated before substantial degradation of lithium-ion battery cell performance.

In some embodiments, LFMP 102 may be in the form of particles such as secondary particles. The particles may have a D50 size range of greater than 0 and at most 5 p.m. In some embodiments, the particles may have a D50 size range of 800 nm to 5 μm. In some examples, additionally or alternatively, the particles may have a D50 size range of 800 nm to 4 μm, 800 nm to 3 μm, 800 nm to 2 μm, 800 nm to 1 μm, 1 μm to 5 μm, 2 μm to 5 μm, 3 μm to 5 μm, or 4 μm to 5 μm. In some embodiments, the particles may be secondary particles formed from primary particles having a size range of greater than 0 and at most 100 nm. In some embodiments, milling, such as milling 103, may be used to tune the D50 size range of the secondary particles during, or prior to, mixing, in formation of blended active material slurry 112. For example, in some embodiments, in order to tune a D50 size range of the secondary particles, the particles may be reduced through attrition by a wet milling process.

In some embodiments, during preparation of a blended active material cathode 116, LFMP 102 may be mixed with a solvent 104 to obtain a mixture. The solvent 104 may be N-methyl-2-pyrrolidone (NMP). Other solvents may be used as known to one skilled in the art.

In some embodiments, during preparation of the blended active material cathode 116, conductive carbon 106 may be added to the mixture of LFMP 102 and solvent 104. The conductive carbon 106 may comprise up to 15% of physical solids in the mixture. In some embodiments, the conductive carbon 106 may be 10% or less, or 5% or less of physical solids in the mixture. In some embodiments, the conductive carbon 106 may be 1-15%, 1-10%, 1-8%, 1-6%, 3-10%, 3-8%, 5-15%, 5-10%, or 5-8% of physical solids in the mixture. In one example, the conductive carbon 106 comprises 5% of physical solids in the mixture. In some embodiments, the conductive carbon 106 may comprise one or more conductive additives. A form or composition of the conductive carbon 106 used is not particularly limited and may be any known by one skilled in the art. For example, the conductive carbon 106 source may comprise polyvinyl alcohol, polyvinyl butyral, sugar, or other source, or a combination of sources.

In some embodiments, a polymeric binder 108 may be added to the mixture of LFMP 102, solvent 104, and conductive carbon 106. In one embodiment, the binder 108 may be polyvinylidene fluoride (PVDF). Other binders may be used as known to one skilled in the art.

Component B 110, or NCM 110,may be added to the mixture of LFMP 102, solvent 104, conductive carbon 106, and binder 108, to form the blended active material slurry 112. The NCM 110 may have a general formula of Li_{a′}Ni_{x′}Co_{y′}Mn_{1-x′-y′}(O₂)_{b}. The formula for NCM 110 may be lithium-rich, such that a′>1, or the formula may be stoichiometric such that a′=1. In one example, 1.0≤a′≤1.10. The NCM 110 may be NCM 111 such that x′=1/3 and y′=1/3, or x′=0.33 and y′=0.33. The NCM 110 may be oxygen rich, such that b>1, or the NCM 110 may be stoichiometric, such that b=1. In one example, 1.0≤b≤1.10. In one example, the NCM 110 may have an overall composition of Li_{a′}Ni_{x′}Co_{y′}Mn_{1-x′-y′}(O₂)_{b} wherein 1.0≤a′≤1.10, x′>0, y′>0, x′+y′<1.0, and 1.0≤b≤1.10. Component B 110 may have a layered structure. In one or more examples, Component B 110 may comprise one or more of NCM, NCA, spinel or layered structure LiMn_{x′}Ni_{2-x′}O₄, or other high nickel cathode material, and/or one or more of any precursor of said materials, such as Ni_{x′}Mn_{y′}Co_{1-x′-y′}(OH)₂.

NCM 110 may be in the form of particles such as secondary particles. The particles may have a D50 size range of 1 to 10 μm, or may have a D50 size of about 5 μm. The D50 size range of the particles of NCM 110 may overlap with the size range of the particles of LFMP 102, or one may be larger than the other. In some embodiments, the D50 size of the particles of LFMP 102 may be 800 nm and the D50 size of the particles of NCM 110 may be 5 μm. In some embodiments, the D50 size of each of the particles of LFMP 102 and the particles of NCM 110 may be about 5 μm. In some embodiments, the D50 size of the particles of NCM 110 may be about 5 μm and the D50 size of the particles of LFMP 102 may be between 800 nm and 5 μm. In one example, NCM 110 may be secondary particles comprising agglomerations of chemically bound, nanometer-sized primary particles.

The blended cathode active materials may comprise more component B 110 than component A 102. In other words, the blended cathode active materials may comprise less component A 102 than component B 110. In some examples, the blended cathode active materials may comprise more NCM 110 than LFMP 102 by weight. In some examples, the blended cathode active materials may comprise less LFMP 102 than NCM 110 by weight.

The blended active material slurry 112 may be a mixture comprising component A 102, solvent 104, conductive carbon 106, binder 108, and component B 110. The blended active material slurry 112 may have a blend ratio of component A 102 to component B 110 wherein 0<component A 102≤40% and 60%≤component B<100%. In some embodiments, a component A:component B ratio may be about 1:99, 5:95, 10:90, 15:85, 20:80, 25:75, 30:70, 35:65, or 40:60. In one example, the component A:component B ratio may be at most 40:60.

In some embodiments of a manufacture of a blended active material cathode 116, or of a Li-ion cell, such as third Li-ion cell 130, with blended active material cathode 116, the blended active material slurry 112 may be deposited, or cast, onto a conductive substrate to form blended active material slurry on a conductive substrate 114 (also referred to herein as a “current collector”). The current collector may be a metal foil, such as aluminum foil. The blended active material slurry 112 may be cast at a pre-determined thickness, and may be cast using a slot-die coater, doctor-blade method, or other method known in the art.

In some embodiments, after the blended active material slurry 112 is deposited onto a current collector, solvent 104 may be dried off, or evaporated, with gentle heating. A resultant dry film may then be calendared to a pre-determined density. After evaporation of solvent 104 and calendaring, the blended active material cathode 116 may be formed. Thus, fabricating the blended active material cathode 116 may comprise mixing component A 102 and component B 110 into blended active material slurry 112, coating said slurry 112 onto a conductive substrate, drying the blended active material slurry on the conductive substrate 114, compressing the coating, and calendaring.

In some embodiments, there may be little to no chemical bonding or hard bonding between particles of component A 102 and particles of component B 110. In some examples, there may be ionic bonding or other mechanical bonding, such that the particles of each of component A 102 and component B 110 are soft bonded. In some examples, the particles of each of component A 102 and component B 110 are in a physical mixture with no chemical bonding between particles of component A 102 and particles of component B 110.

The blended active material cathode 116 may be suitable for assembly into first Li-ion cell 126. The process of forming the first Li-ion cell 126 may comprise pairing the cathode 116 with an anode 120 and with a separator 118 sandwiched in between the cathode 116 and the anode 120. The anode 120 may be one or more of lithium metal, graphite, lithium titanate (LTO), silicon, or other material known in the art. The separator 118 may serve to separate the anode 120 and the cathode 116 so as to avoid physical contact. In a preferred embodiment, the separator 118 has a high porosity, excellent stability against electrolytic solution, and excellent liquid-holding properties. Example materials for the separator 118 may be selected from nonwoven fabric or porous film made of polyolefins, such as polyethylene or polypropylene, or ceramic-coated materials.

The blended active material cathode 116, separator 118, and anode 120 may be placed within a hermetically-sealed cell housing 122, such as a pouch.

First Li-ion cell 126 may then be filled with electrolyte 124 to produce filled, second Li-ion cell 128. The electrolyte 124 may support movement of ions, and may further be in contact with components of the second Li-ion cell 128. The electrolyte 124 may comprise Li salts, organic solvents, such as organic carbonate solvents, and/or additives. The electrolyte 124 may be present throughout second Li-ion cell 128 and may further be in physical contact with the anode 120, cathode 116, and separator 118.

Second Li-ion cell 128 may then undergo cell formation, referred to also as a first charge/discharge cycle, to form third Li-ion cell 130. Third Li-ion cell 130 may be a fully fabricated and complete battery cell ready for insertion for use in Li-ion battery 132 in conjunction with other similarly manufactured Li-ion cells. Third Li-ion cell 130 may store energy as a chemical potential in component electrodes (e.g., cathode 116 and anode 120), wherein the electrodes may be configured to reversibly convert between chemical and electrical energy via redox reactions.

In this way, Li-ion battery 132 may be fabricated wherein a blend of cathode active materials may be used to prepare at least one blended active material cathode 116 of component battery cells of the Li-ion battery 132. In particular, the Li-ion battery 132 may include one or more battery cells, wherein each of the battery cells may be third Li-ion cell 130. The one or more battery cells may include cathode 116 containing the blended cathode active materials, separator 118, electrolyte 124, and anode 120. The blended active material cathode 116 may be prepared by mixing component A 102, solvent 104, conductive carbon 106, binder 108, and component B 110 to form blended active material slurry 112 which is subsequently applied to a current collector and dried and calendared.

In one example, Li-ion battery 132 may comprise the cathode 116 and a complementary anode 120, wherein Li-ion battery 132 may be further arranged in a device, where the device may be an electric vehicle, a hybrid-electric vehicle, a cell phone, a smart phone, a global positioning system device, a tablet device, or a computer.

In some embodiments, the process of forming a blended active material cathode 116 may be different than described above. In some embodiments, component A 102 and component B 110 may be dry-mixed to form a dry active material blend. In some embodiments, the blended active material slurry 112 may be dried before application onto a current collector, so as to achieve a dry active material blend powder. In some embodiments, additional additives or processes may be included or, alternatively, an additive or process may be removed or substantially altered.

FIGS. 2 and 3 show test results for charge/discharge DCR of battery cells utilizing blended cathode active materials. In a Li-ion cell wherein LFMP acts as the positive electrode, two lithium de-insertion plateaus occur in a voltage vs. charge capacity plot: one centered at 3.5 V vs. Li and one centered at 4.1 V vs. Li. The 3.5 V plateau largely corresponds to the following redox reaction:

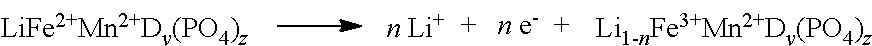

The 4.1 V plateau largely corresponds to the following redox reaction:

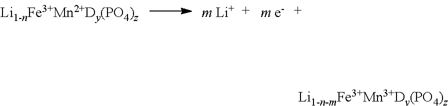

Similarly, upon discharge, or Li-ion insertion, two plateaus occur in a voltage vs. discharge capacity plot: one centered at 4.0 V vs. Li and one centered at 3.45 V vs. Li. These reactions largely correspond to the reverse reactions described above and are centered on the Mn and Fe atoms, respectively.

Obtaining low DCR (and therefore high power) with Li-ion cells which employ NCM active materials may require maximizing each of the ionic and electronic conductivities of the active material at a particle level. Practically speaking, the ionic conductivity is inversely related to particle size and porosity. The NCM active materials used herein may have a D50 particle size on an order of 5 μm. In some embodiments, the D50 particle size of the NCM active materials may be in the range of 1-10 μm. The NCM active materials may have a Brunauer-Emmett-Teller (BET) surface area of >0.5 m²/g. In some embodiments, the BET surface area of the NCM active materials may be >1 m²/g.

The electronic conductivity may be adjusted based on inclusion of dopants, conductive coatings, and tuning bulk composition. In general, an electronic conductivity trend for NCM active materials may be directly proportional with a fraction of cobalt in a given particle, meaning that, for example, NCM 111 is more electronically conductive then NCM 622. In a Li-ion cell wherein NCM 111 acts as a positive electrode, an onset of a smooth, gently-sloping plateau is observed at 3.75 V vs. Li during a charge step. This lithium de-insertion plateau corresponds to a mixture of nickel- and cobalt-centered redox reactions. The extent of lithium de-insertion is controlled by the upper cutoff voltage. This voltage is typically capped no higher than 4.4 V vs. Li in order to mitigate deleterious side reactions associated with irreversible phase transitions at a surface of the particle and electrolyte oxidation.

Based on experimental results, the inventors herein have identified several factors relating to obtaining low DCR with cathodes consisting of physical mixtures of LFMP (component A) 102 and NCM (component B) 110.

Blend Ratio of Component A 102 to Component B 110. From cost and abuse tolerance standpoints, it may be advantageous to maximize a contribution of component A 102. From a capacity density (mAh/g and mAh/cm³) standpoint, it may be advantageous to maximize a contribution of component B 110. Balancing these factors needs to be considered to arrive at a target blend ratio. The inventors herein have found that active material ratios of 0 <component A≤0.4 and, conversely, 0.6≤component B<1.0 benefit from beneficial qualities of each of component A 102 and component B 110, and thus may be commercially attractive.

Voltage Overlap Between Component A 102 and Component B 110. DCR benefits of blended active material cathodes 116 may only be present when working voltages of each of component A 102 and component B 110 are compatible. Consequently, blended active material cathodes 116 may be disadvantageous when voltage compatibility is poor. A ratio between component A 102 and component B 110 may also need to be considered so as to keep voltage profiles as smooth as possible. In general, as the fraction of component A 102 changes relative to component B 110, a composition of component A 102 must also change to retain benefits to a Li-ion battery including the blended active material cathode 116. Specifically, fractions of Mn and Fe may be selected to maximize voltage overlap. For blended active material cathodes 116, one exemplary blend which may provide good voltage overlap (and hence good DCR at a wide SOC range) is Li_{1.05}Fe_{0.34}Mn_{0.63}D_{0.03}(PO₄) blended with NCM 111 in a 0.3:0.7 ratio.

Specific Capacity Overlap Between Component A 102 and Component B 110. On a mass basis, a reversible charge capacity in a working voltage range may be similar. This may avoid significant increases in mass loadings (vs. a mono-component cathode) for a given electrode area which may diminish the electrochemical performance and abuse tolerance gains that blending may provide.

The power (and DCR) performance of a blended cathode may be evaluated by a hybrid pulse power characterization (HPPC) test. The HPPC test measures a voltage drop under high current discharge and charge conditions at increments spanning a full SOC range. FIG. 2 shows charge (plot 202) and discharge (plot 252) DCR vs. SOC of blended and unblended cathodes measured by the HPPC test at 23° C. Curve 204 shows the DCR vs. SOC at 3.5 C charge of LFMP comprising 65% Mn. Curve 204 shows a large increase in DCR at around 30% SOC. Curve 206 shows the DCR vs. SOC at 3.5C charge of NCM 111. Curve 206 shows a consistently lower DCR than curve 204, as well as a lack of significant DCR spikes. Curve 208 shows the DCR vs. SOC at 3.5C charge of a blended material comprising 20% LFMP (comprising 65% Mn) and 80% NCM 111. Curve 208 shows that between 20% and 80% SOC, the DCR of the blended material correlates closely with that of pure NCM 111 (curve 206). Notably, there is no DCR peak at 30% SOC, as seen with LFMP (curve 204). The DCR of curve 208 so closely matching that of curve 206 suggests a synergetic relationship between the LFMP and NCM 111 in the blended material. That is, despite the fact that 20% of the blended material (e.g., the LFMP) has a higher DCR when tested by itself, as evidenced by curve 204, the DCR of the blended material remains relatively flat and no greater than that of pure NCM 111 (curve 206).

Plot 252 shows a similar synergetic effects upon DCR happens during discharge as well. Curve 254 shows the DCR vs. SOC at 5 C discharge of LFMP comprising 65% Mn. Curve 254 shows a large increase in DCR at around 30% SOC. Curve 256 shows the DCR vs. SOC at 5 C discharge of NCM 111. The curve 256 shows a consistently lower DCR than curve 254, as well as a lack of significant DCR spikes. Curve 258 shows the DCR vs. SOC at 5 C charge of the blended material. Curve 258 shows that between 20% and 80% SOC, the DCR of the blended material correlates closely with that of pure NCM 111 (curve 256). Notably, there is no DCR peak at 30% SOC, as seen with LFMP (curve 254). The DCR of curve 258 so closely matching that of curve 256 again suggests a synergetic relationship between the LFMP and NCM 111 in the blended material. That is, despite the fact that 20% of the blended material (e.g., the LFMP) has a higher DCR when tested by itself, as evidenced by curve 254, the DCR of the blended material remains relatively flat and no greater than that of pure NCM 111 (curve 256).

Turning now to FIG. 3, plot 302 shows discharge DCR for a plurality of full cells, wherein each full cell incorporates one of a plurality of blended cathode active material compositions. Blended cathode active materials of each full cell have a weight ratio of 80% NCM 111 and 20% of a lithium transition-metal phosphate. The lithium transition-metal phosphate may be lithium iron phosphate (LFP; curve 304), lithium manganese phosphate (LMP; curve 306), LMFP comprising 45% Mn (curve 308), and LMFP comprising 65% Mn (curve 310). Plot 352 shows a magnified view of curves 308 and 310 in a lower-left section of plot 302 to highlight differences in discharge DCR trends.

As shown by plot 302, full cells incorporating LFP and LMP blends (curves 304 and 306, respectively) display higher DCR at low SOC values than do LMFP blends (curves 308 and 310). Inclusion of Mn in the lithium transition-metal phosphate, however, results in flat and maintained discharge DCR across a range of SOC values. Such a Mn benefit is seen in the LMP blend (curve 306) as well as the LMFP blends (curves 308 and 310). Further, the LMFP blend comprising 65% Mn in the LMFP (curve 310) shows consistently lower discharge DCR than the LMFP blend comprising 45% Mn in the LMFP (curve 308). Plot 352 further illustrates the lower discharge DCR in curve 310 relative to curve 308, magnifying discharge DCR values at a lower subset of the range of SOC values. As such, NCM blended with high-Mn lithium transition-metal phosphate is observed to maintain performance across a broad SOC range.

Turning now to FIG. 4, a method 400 is provided for fabricating a blended active material cathode. The blended active material cathode may be blended active material cathode 116, wherein said cathode and further components (e.g., component A 102, component B 110, etc.) described in reference to method 400 may be further detailed above in reference to FIG. 1.

Method 400 begins at 402, wherein component A 102 may be mixed with, and dissolved into, a solvent 104 (e.g., NMP) to obtain a mixture. As an example, a weight percentage of component A 102 dissolved in solvent 104 may be more than 0 wt % to about 40 wt %. In another example, the weight percentage of component A 102 dissolved in solvent 104 may be between about 10 wt % and 30 wt %, or about 20 wt %. In one example, the method 400 at 402 may comprise forming a dissolved LFMP solution by dissolving particles of LFMP 102 in NMP or another solvent 104.

At 404, conductive carbon 106 may be added to the mixture. A form or composition of conductive carbon 106 is not particularly limited and may be any kind known by one skilled in the art. For example, conductive carbon 106 may comprise graphite, graphene, ketjen black, carbon black, or another form or composition of conductive carbon 106. Conductive carbon 106 may include, or be substituted by, other conductive additives including, but not limited to, metal powders, metal oxides, and/or conductive polymers. In one example, conductive carbon 106 may be added between 0 wt % and about 15 wt %. For example, a percent by mass of conductive carbon 106 may be between 0% and about 15% of all combined solids in the mixture. In another example, conductive carbon 106 may be added at between 0 wt % and about 5 wt %. In yet another example, conductive carbon 106 may be added at about 5 wt % to about 10 wt %. In one example, conductive carbon 106 is added at 5 wt %.

At 406, binder 108 may be added to the mixture. Binder 108 may be PVDF or one or more other binders as known to one skilled in the art.

At 408, component B 110 may be added to the mixture. Component B 110 may be NCM 110. NCM 110 may have a general formula of Li_{a′}Ni_{x′}Co_{y′}Mn_{1-x′-y′}O₂. The formula for NCM 110 may be lithium-rich, such that a′>1, or the formula may be stoichiometric such that a′=1. The NCM 110 may be NCM 111 such that x′=1/3 and y′=1/3, or x′=0.33 and y′=0.33. Component B 110 may have a layered structure. In one example, the percent by mass of component A 102 may be more than 0% to about 40% of the total weight of component A 102 and component B 110. In an additional or alternative example, the percent by mass of component B 110 may be about 60% to less than 100% of the total weight of component A 102 and component B 110.

NCM 110 may be in the form of particles such as secondary particles. The particles may have a D50 size range of 1 to 10 μm, or may have a D50 size of about 5 μm. The D50 size range of the particles of NCM 110 may overlap with the size range of the particles of LFMP 102, or one may be larger than the other. In some embodiments, the D50 size of the particles of LFMP 102 may be 800 nm and the D50 size of the particles of NCM 110 may be 5 μm. In some embodiments, the D50 size of each of the particles of LFMP 102 and the particles of NCM 110 may be about 5 μm. In some embodiments, the D50 size of the particles of NCM 110 may be about 5 μm and the D50 size of the particles of LFMP 102 may be between 800 nm and 5 μm.

At 410 the mixture may be cast, or deposited, onto a current collector (e.g., metal foil, such as aluminum foil). A slot-die coater, doctor-blade method, or other technique may be used at 410 to cast the mixture at a pre-determined thickness.

At 412, the solvent may be evaporated from the mixture to obtain a dried blended active material. In one example, the mixture may be heated to increase a speed of evaporation.

At 414, the dried blended active material may be calendared to a predetermined density. Method 400 then ends.

In a further example, lithium-ion cells comprising the blended cathode active material as described herein may provide improved abuse-tolerance characteristics. For example, the lithium-ion cells show improved performance during nail penetration abuse tests. In particular, the lithium-ion cells comprising blended cathode active materials as described herein, including at least LFMP and NCM wherein particle distributions, working voltages, and/or specific capacities of each of the LFMP and NCM overlap, show improved abuse tolerance.

In this way, a safer, longer-lasting battery may be achieved by blending high-manganese LFMP active material with NCM active material for use as a cathode for a lithium-ion battery. In particular, less oxygen release under abuse conditions by a resultant combined active material is seen than in NCM alone. This phenomenon of mitigating oxygen gas may prevent a decrease in a flash point of an electrolyte in the battery. Thus, a technical effect of increasing battery safety and reducing battery fire is achieved through blending active materials as disclosed herein.

Further, a technical effect of mitigating a relatively high DCR of LFMP is accomplished herein. NCM is shown to mitigate both the relatively high DCR and associated DCR spikes of LFMP. In this way, a high power battery may be fabricated which provides a large, gently-sloping voltage curve between 20% and 80% SOC. This allows a battery management system (BMS) to effectively regulate and control battery SOC in a MHEV, for example.

In one example, a blended cathode active material for a lithium-ion battery comprises a lithium iron manganese phosphate (LFMP), the LFMP comprising at least 40 wt % of Mn, and a lithium nickel cobalt manganese oxide (NCM), wherein there is less of the LFMP than the NCM by weight. A first example of the blended cathode active material further includes wherein the LFMP has an overall composition of LiₐFe_{1-x-y}MnₓD_{y}(PO₄)F_{w}, wherein 1.0≤a≤1.10, 0.45<x≤0.85, 0≤y≤0.1, 1.0<z≤1.1, 0≤w<0.1, and D may be selected from the group consisting of Ni, V, Co, Nb, and combinations thereof. A second example of the blended cathode active material, optionally including the first example of the blended cathode active material, further includes wherein the LFMP is lithium-rich. A third example of the blended cathode active material, optionally including one or more of the first and second examples of the blended cathode active material, further includes wherein 0.60≤x≤0.85. A fourth example of the blended cathode active material, optionally including one or more of the first through third examples of the blended cathode active material, further includes wherein the LFMP is in the form of particles having a D50 size range of 800 nm to 5 μm. A fifth example of the blended cathode active material, optionally including one or more of the first through fourth examples of the blended cathode active material, further includes wherein a percent by mass of the LFMP is more than 0% and less than about 40% of a total weight of the LFMP and the NCM. A sixth example of the blended cathode active material, optionally including one or more of the first through fifth examples of the blended cathode active material, further includes wherein the NCM has an overall composition of Li_{a′}Ni_{x′}Co_{y′}Mn_{1-x′-y′}(O₂)_{b}, wherein 1.0≤a′≤1.10, x′>0, y′>0, x′+y′<1.0, and 1.0≤b≤1.10. A seventh example of the blended cathode active material, optionally including one or more of the first through sixth examples of the blended cathode active material, further includes wherein x′=0.33 and y′=0.33. An eighth example of the blended cathode active material, optionally including one or more of the first through seventh examples of the blended cathode active material, further includes wherein the NCM is in the form of particles having a D50 size of about 5 μm. A ninth example of the blended cathode active material, optionally including one or more of the first through eighth examples of the blended cathode active material, further includes wherein the NCM has a Brunauer-Emmett-Teller surface area of >1 m²/g. A tenth example of the blended cathode active material, optionally including one or more of the first through ninth examples of the blended cathode active material, further includes wherein a percent by mass of the NCM is about 60% to less than 100% of the total weight of the LFMP and the NCM. An eleventh example of the blended cathode active material, optionally including one or more of the first through tenth examples of the blended cathode active material, further includes wherein the LFMP:NCM ratio is about 30:70. A twelfth example of the blended cathode active material, optionally including one or more of the first through eleventh examples of the blended cathode active material, further includes wherein working voltages of the LFMP and the NCM overlap. A thirteenth example of the blended cathode active material, optionally including one or more of the first through twelfth examples of the blended cathode active material, further includes wherein specific capacities of the LFMP and the NCM overlap.

In another example, a method comprises mixing a first amount of a lithium iron manganese phosphate with a solvent to obtain a mixture, the lithium iron manganese phosphate comprising at least 60 wt % of Mn, adding conductive carbon to the mixture, adding a binder to the mixture, adding a second amount of a lithium nickel cobalt manganese oxide to the mixture, the second amount of the lithium nickel cobalt manganese oxide being greater by weight than the first amount of the lithium iron manganese phosphate, casting the mixture onto a current collector, evaporating the solvent from the mixture to obtain a dried blended active material, and calendaring the dried blended active material. A first example of the method further includes wherein the conductive carbon is added at between 0 wt % and about 5 wt %. A second example of the method, optionally including the first example of the method, further includes wherein the binder is polyvinylidene fluoride. A third example of the method, optionally including one or more of the first and second examples of the method, further includes wherein the solvent is N-methyl-2-pyrrolidone.

In yet another example, a lithium-ion battery comprises a cathode and an anode in communication via an electrolyte, wherein the cathode comprises a lithium iron manganese phosphate (LFMP) and a lithium nickel cobalt manganese oxide (NCM), wherein there is more of the NCM than the LFMP and the LFMP comprises at least 60 wt % of Mn. A first example of the lithium-ion battery further includes wherein the lithium-ion battery is arranged in a device, wherein the device is an electric vehicle, a hybrid-electric vehicle, a cell phone, a smart phone, a global positioning system device, a tablet device, or a computer.

Various modifications of the present invention, in addition to those shown and described herein, will be apparent to those skilled in the art of the above description. Such modifications are also intended to fall within the scope of the appended claims. The foregoing description is illustrative of particular embodiments of the invention, but it is not meant to be a limitation upon the practice thereof. The foregoing discussion should be understood as illustrative and should not be considered limiting in any sense. While inventions have been particularly shown and described with references to preferred embodiments thereof, it will be understood by those skilled in the art that various changes in form and details may be made therein without departing from the spirit and scope of the inventions as defined by the claims. The corresponding structures, materials, acts and equivalents of all means or steps plus function elements in the claims below are intended to include any structure, material or acts for performing the functions in combination with other claimed elements as specifically claimed.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A blended cathode active material for a lithium ion battery, the blended cathode active material comprising:
a lithium iron manganese phosphate (LFMP), the LFMP comprising a molar ratio of Mn of greater than 0.60 and less than 0.70; and
a lithium nickel cobalt manganese oxide (NCM), wherein
there is less of the LFMP than the NCM by weight.

2. The blended cathode active material of claim 1, wherein the LFMP has an overall composition of LiₐFe_{1-x-y}MnₓD_{y}(PO₄)_{z}F_{w}, wherein 1.0≤a≤1.10, 0.60<x<0.70, 0≤y≤0.1, 1.0<z≤1.1, 0≤w<0.1, and D may be selected from the group consisting of Ni, V, Co, Nb, and combinations thereof.

3. The blended cathode active material of claim 1, wherein the LFMP is lithium-rich.

4. The blended cathode active material of claim 2, wherein 0.65≤x<0.70.

5. The blended cathode active material of claim 1, wherein the LFMP is in the form of particles having a D50 size range of 800 nm to 5 μm.

6. The blended cathode active material of claim 1, wherein a percent by mass of the LFMP is more than 0% and less than or equal to 40% of a total weight of the LFMP and the NCM.

7. The blended cathode active material of claim 1, claims, wherein the NCM has an overall composition of Li_{a′}Ni_{x′}Co_{y′}Mn_{1-x′-y′}(O₂)_{b}, wherein 1.0≤a′≤1.10, x′>0, y′>0, x′+y′<1.0, and 1.0≤b≤1.10.

8. The blended cathode active material of claim 1, wherein x′=0.33 and y′=0.33.

9. The blended cathode active material of claim 1, wherein the NCM is in the form of particles having a D50 size range of 1 to 10 μm.

10. The blended cathode active material of claim 1, wherein the NCM has a Brunauer-Emmett-Teller surface area of >1 m²/g.

11. (canceled)

12. The blended cathode active material of claim 1, wherein the LFMP:NCM ratio is 30:70.

13. The blended cathode active material of claim 1, wherein working voltages of the LFMP and the NCM overlap.

14. The blended cathode active material of claim 1, wherein specific capacities of the LFMP and the NCM overlap.

15. A method, comprising:
mixing a first amount of a lithium iron manganese phosphate with a solvent to obtain a mixture, the lithium iron manganese phosphate comprising a molar ratio of Mn of greater than 0.60 and less than 0.70;
adding a conductive carbon to the mixture;
adding a binder to the mixture;
adding a second amount of a lithium nickel cobalt manganese oxide to the mixture, the second amount of the lithium nickel cobalt manganese oxide being greater by weight than the first amount of the lithium iron manganese phosphate;
casting the mixture onto a current collector;
evaporating the solvent from the mixture to obtain a dried blended active material; and
calendering the dried blended active material.

16. The method of claim 15, wherein the conductive carbon is included in the mixture at 5% or less of physical solids in the mixture.

17. The method of claim 15, wherein the binder is polyvinylidene fluoride.

18. The method of claim 15, wherein the solvent is N-methyl-2-pyrrolidone.

19. A lithium-ion battery, comprising:
a cathode and an anode in communication via an electrolyte, wherein
the cathode comprises a lithium iron manganese phosphate (LFMP) and a lithium nickel cobalt manganese oxide (NCM), wherein
there is more of the NCM than the LFMP; and wherein
the LFMP comprises a molar ratio of Mn of greater than 0.60 and less than 0.70.

20. The lithium-ion battery of claim 19, wherein the lithium-ion battery is arranged in a device, wherein the device is an electric vehicle, a hybrid-electric vehicle, a cell phone, a smart phone, a global positioning system device, a tablet device, or a computer.

21. The lithium-ion battery of claim 19, wherein the LFMP is Li_{1.05}Fe_{0.34}Mn_{0.63}D_{0.03}(PO₄),
wherein the NCM is NCM 111, and
wherein the LFMP is blended with the NCM at a ratio of 0.3:0.7.
